(19) United States
(12) Patent Application Publication
(10) Pub. No.: US 2013/0120924 A1
(43) Pub. Date: May 16, 2013

(54) POWER SUPPLY SYSTEM FOR MEMORY MODULES AND ADAPTER BOARD THEREOF

(71) Applicants: KANG WU, Shenzhen City (CN); Bo Tian, Shenzhen City (CN)

(72) Inventors: KANG WU, Shenzhen City (CN); Bo Tian, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/585,766

(22) Filed: Aug. 14, 2012

(30) Foreign Application Priority Data
Nov. 11, 2011 (CN) 201110356646.X

(51) Int. Cl. G06F 1/18

(52) U.S. Cl. 361/679.31

(57) ABSTRACT

An exemplary power supply system includes a plurality of adapter boards. Each adapter board is connected to a single power supply and is installed with a memory module. Each adapter board receives a first direct current (DC) voltage from the power supply and transforms the first DC voltage into a second DC voltage, and outputs the second DC voltage to the memory module.

### BACKGROUND

1. Technical Field

The disclosure generally relates to a power supply system for memory modules and an adapter board thereof.

2. Description of the Related Art

Many memory modules are mounted in memory slots of a computer system. These memory modules receive voltage from a voltage regulator-down (VRD) arranged on a motherboard of the computer system through the memory slots. However, the VRD will provide full power to these memory slots, even when a number of the memory modules installed is less than a rated number, thereby wasting energy.

Therefore, there is room for improvement within the art.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views. Wherever possible, the same reference numbers are used throughout the drawings to refer to the same or like elements of an embodiment.

FIG. 1 is a block diagram of a power supply system, according to an exemplary embodiment, and showing the power supply system connected to a motherboard.

FIG. 2 is a schematic view of an adapter board of the power supply system shown in FIG. 1.

### DETAILED DESCRIPTION

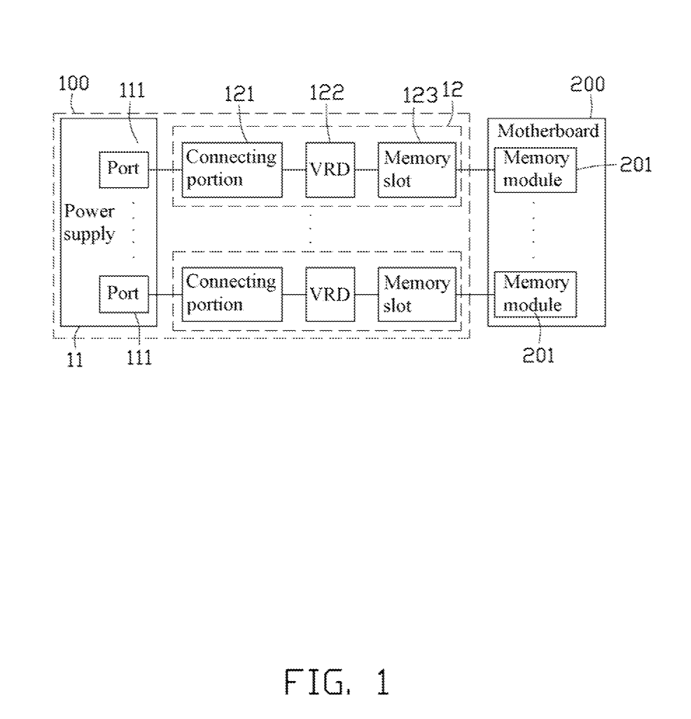

FIG. 1 is a block diagram of a power supply system 100, according to an exemplary embodiment. The power supply system 100 provides voltages to a plurality of memory modules 201 which are mounted on a motherboard 200 of an electronic device, such as a computer or a server, for example. Each memory module 201 may be a dual in-line memory module (DIMM). The power supply system 100 includes a power supply 11 and a plurality of adapter boards 12 corresponding to the plurality of memory modules 201. Each adapter board 12 can be electronically connected to the power supply 11, and each memory module 201 of the motherboard 200 can be electronically connected to the power supply 11 through one adapter board 12.

In one embodiment, the power supply 11 is an external power source and provides a first direct current (DC) voltage to the plurality of adapter boards 12. The power supply 11 includes a plurality of ports 111 corresponding to the plurality of adapter boards 12. Each port 111 may be a universal serial bus (USB) port. In one embodiment, the first DC voltage provided by the power supply 11 is about 12V (volts).

Each adapter board 12 includes a connecting portion 121, a voltage regulator-down (VRD) 122, and a memory slot 123. The connecting portion 121 may be a USB line and be set on a side of the adapter board 12. The connecting portion 121 cooperates with the port 111, and is connected to the power supply 11 through the port 111, thereby receiving the first DC voltage from the power supply 11. The VRD 122 is electronically connected to the connecting portion 121, and receives the first DC voltage and transforms the first DC voltage into a second DC voltage. In this embodiment, the second DC voltage is less than the first DC voltage and equal to a rated voltage of a memory 201, such as 1.5V, for example. The memory slot 123 is electronically connected to the VRD 122. The memory slot 123 is configured to receives memory module 201, and outputs the second DC voltage to the memory module 201. Each memory slot 123 may be a DIMM slot.

In use, when only one memory module 201 of the motherboard 200 is used, the memory module 201 is inserted in the memory slot 123 of one of the plurality of adapter boards 12 and is electronically connected to the adapter board 12. Then, the adapter board 12 configured with the memory module 201 is electronically connected to the power supply 11 through the connection between the connecting portion 121 of the adapter board 12 and one of the ports 111 of the power supply 11. In this way, the power supply 11 outputs a predetermined first DC voltage to the adapter board 12 configured with the memory module 201. The VRD 122 of the adapter board 12 receives the first DC voltage through the connecting portion 121 and transforms the first DC voltage into the second DC voltage. Thus, the second DC voltage can be transmitted to the memory module 201 through the memory slot 123 of the adapter board 12 to provide power to the memory module 201.

Similarly, when a plurality of memory modules 201 of the motherboard 200 are installed on the motherboard 200, each memory module 201 is installed into an adapter board 12 according to the above manner, and then the adapter board 12 is connected to the power supply 11. In this way, the plurality of adapter boards 12 can share the first DC voltage from the power supply 11 and provide the second DC voltage (i.e., full power) to a memory module 201, thereby each adapter board 12 is fully utilized if utilized at all, and this saves energy.

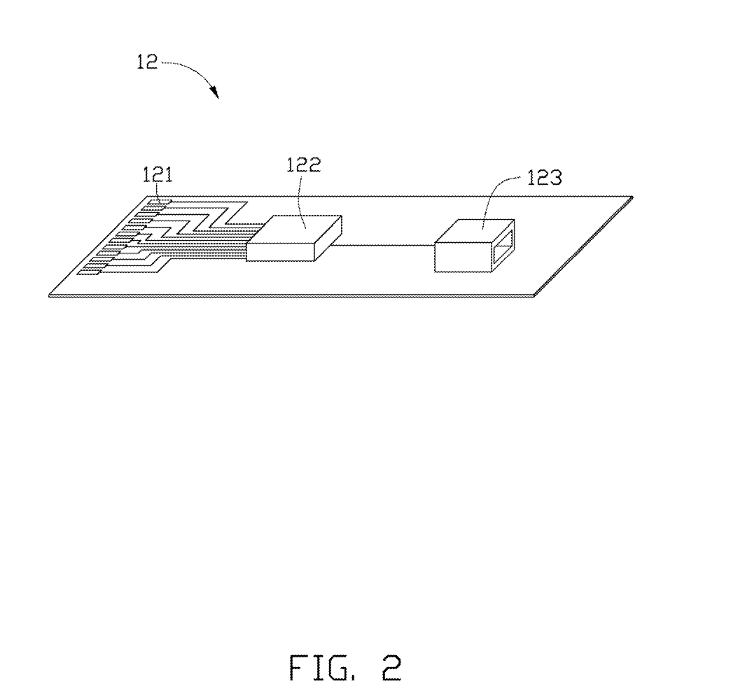

Referring to FIG. 2, the power supply 11 can also be integrated with a switching power supply (not shown) of the motherboard 200. In detail, when the power supply 11 is integrated with the switching power supply, each port 111 may be a power slot. The connecting portion 121 of the adapter board 12 may be a gold finger and by means of the gold finger being inserted in the power slot, any plurality of adapter boards 12 can share the power supply 11.

Accordingly, in use of the power supply system 100, the memory module 201 is assembled into an adapter board 12, which makes a memory module 201 correspond to an adapter board 12. In this way, the plurality of memory modules 201 can each work independently to ensure each adapter board 12 being fully utilized to save energy. Furthermore, due to the integration of the connecting portion 121, the VRD 122 and the memory slot 123 on an adapter board 12, when a memory module 201 received in an adapter board 12 is not being used, the adapter board 12 can be disconnected from the power supply 11 at any time, and be removed from the power supply system 100 altogether, thereby simplifying the structure of the motherboard 200.

In the present specification and claims, the word “a” or “an” preceding an element does not exclude the presence of a plurality of such elements. Further, the word “comprising” does not exclude the presence of elements or steps other than those listed.

It is to be also understood that even though numerous characteristics and advantages of exemplary embodiments have been set forth in the foregoing description, together with details of the structures and functions of the embodiments, the disclosure is illustrative only, and changes may be made in detail, especially in the matter of arrangement of parts within the principles of this disclosure to the full extent indicated by the broad general meaning of the terms in which the appended claims are expressed.

What is claimed is:

1. An adapter board, comprising:
a connecting portion connected to a power supply, the power supply outputting a first direct current (DC) voltage;
a voltage regulator-down (VRD) connected to the connecting portion, the VRD transforming the first DC voltage into a second DC voltage; and
a memory slot connected to the VRD, wherein the memory slot receives the second DC voltage and outputs the second DC voltage to a memory module received in the memory slot.

2. The adapter board of claim 1, wherein the second DC voltage is equal to a rated voltage of the memory module.

3. The adapter board of claim 1, wherein the memory slot is a dual in-line memory module slot.

4. A power supply system for memory modules, comprising:
a plurality of adapter boards corresponding to the memory modules; each adapter board connected to a power supply and installed with a memory module; wherein each adapter board receives a first direct current (DC) voltage from the power supply, and transforms the first DC voltage into a second DC voltage, the second DC voltage is output to the memory module received in the memory slot.

5. The power supply system of claim 4, wherein the second DC voltage is equal to a rated voltage of the memory module.

6. The power supply system of claim 4, wherein each adapter board comprises a connecting portion, the connecting portion is connected to the power supply to receive the first DC voltage.

7. The power supply system of claim 6, wherein each adapter board comprises a voltage regulator-down (VRD), the VRD is connected to the connecting portion to receive the first DC voltage and transforms the first DC voltage into the second DC voltage.

8. The power supply system of claim 7, wherein each adapter board comprises a memory slot, the memory slot is connected to the VRD and is installed with a memory module, the memory slot receives and outputs the second DC voltage to the memory module.

9. The power supply system of claim 8, wherein the memory slot is a dual in-line memory module slot.

10. The power supply system of claim 6, wherein the power supply is an external power source and comprises a plurality of ports corresponding to the plurality of adapter boards, each adapter board is connected to the power supply through one port.

11. The power supply system of claim 10, wherein the port is a universal serial bus (USB) port and the connecting portion is a USB line.

12. The power supply system of claim 6, wherein the power supply is a switching power supply of a motherboard, and each port and each connecting portion are respectively a power slot and a gold finger, the gold finger is inserted in a corresponding power slot.
